(19) United States
(12) Patent Application Publication
(10) Pub. No.: US 2002/0078777 A1
(43) Pub. Date: Jun. 27, 2002

(54) Gear assembly

(76) Inventors: David E. Witucki, Bay City, MI (US); Steven J. Schultz, Saginaw, MI (US)

Correspondence Address: EDMUND P. ANDERSON, DELPHI TECHNOLOGIES, INC., Legal Staff, P.O. Box 5052 Mail Code: 480-414-420, Troy, MI, 48007-5052, US

(21) Appl. No.: 09/749,359

(22) Filed: Dec. 27, 2000

(51) Int. Cl. F16H 55/14

(52) U.S. Cl. 74/461

(57) ABSTRACT

A gear assembly includes a dampening layer disposed intermediate to a face and a backing. The dampening layer is preferably injection molded between the face and the backing through one or more openings in the backing. The dampening layer minimizes noise and vibrations associated with gear assemblies and interfaces and reduces the transmission of noise and vibrations through the gear assembly.

### TECHNICAL FIELD

The present invention relates to gear assemblies.

### BACKGROUND OF THE INVENTION

In many gear applications, for example gear applications used in electric power steering (EPS) systems, a face gear is formed of polymeric compounds such as nylon. The nylon is insert molded or overmolded upon a metallic hub or backing plate. The combination of polymeric gear teeth and a metallic hub or backing plate possesses the necessary fatigue, wear, and friction properties without sacrificing the strength and stiffness required to prevent deformations due to gear separating forces generated during operation. Excessive separation creates sub-optimum tooth contact, which may lead to premature wear.

This process generally involves injecting molten nylon into a mold in a manner to surround a specific portion of a metal hub. The teeth are formed adjacent to a face surface of the hub. The teeth generally extend from a wall stock that surrounds the face surface, an edge surface, and a back surface of the hub. Typically, to integrate the wall stock on the face surface and the back surface, holes are formed through the hub. Alternatively, mechanical features may be machined or formed on the face surface, back surface, or circumference of the hub.

While prior art nylon/steel composite gears have been proven reliable and sufficient in many situations, they do not sufficiently dampen noise and vibration, which would be desirable in many applications, including in EPS systems. Prior attempts at dampening noise and vibration included providing an assembly of components with injected elastomeric material for torsional dampening in a steering system intermediate shaft assembly. However, mechanical fasteners, expensive and complex mechanical locking features as well as additional assembly steps are generally required for such assemblies.

It would be desirable to provide noise and vibrational dampening of gearing systems without relying only on complex mechanical locking features or additional assembly operations.

### SUMMARY OF THE INVENTION

The above discussed and other drawbacks and deficiencies are overcome or alleviated by a gear assembly having a gear face with molded gear teeth, a backing plate and a dampening layer disposed between the face and the backing plate. The gear face and teeth are formed of a polymeric material such as nylon.

The dampening layer dampens noise and vibration transmitted through the gearing assembly, as well as minimizing vibrations generated by the interface of gears and/or pinions. The dampening layer also provides shock dampening in situations where the gear set hits a radial stop or a sudden reverse in direction, thus improving durability by minimizing stress and deformation of the gear teeth due to impact loads. The gear displacement occurring when the dampening layer is compressed minimizes the negative effects of minor tooth form errors, such as composite error or face runout. This compressability allows the gear face to seek proper contact during mesh with the mating pinion or gear.

### BRIEF DESCRIPTION OF THE DRAWINGS

The present invention will now be described, by way of example, with reference to the accompanying drawings, in which:

FIG. 1 is a partially exploded isometric view of a preferred embodiment of a gear assembly;

FIG. 2 is a cross-sectional view of a completed gear assembly according to a preferred embodiment;

FIG. 3 is a schematic view of a gear set employing the gear assembly shown in FIG. 1;

FIG. 4 is a sectional view of a mold used in a process step for forming the gear assembly shown in FIG. 2;

FIG. 5 is a sectional view of a mold used in a second process step for forming the gear assembly shown in FIG. 2; and

FIG. 6 is a top view of a portion of the molds shown in FIGS. 4 and 5.

### DESCRIPTION OF EMBODIMENTS OF THE INVENTION

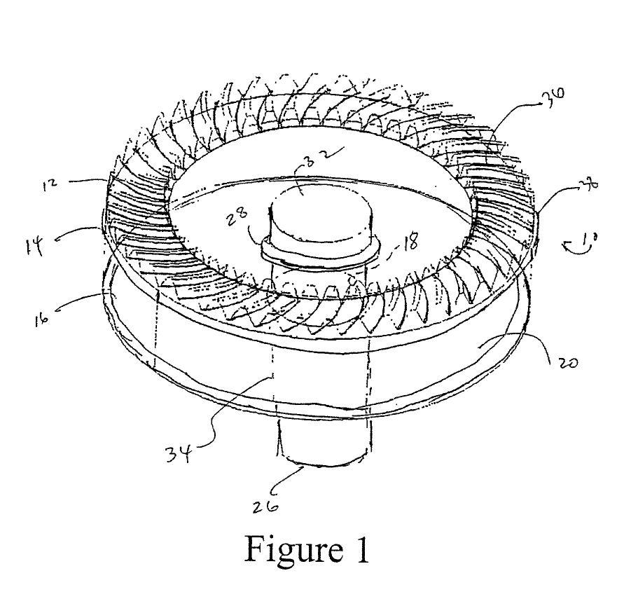

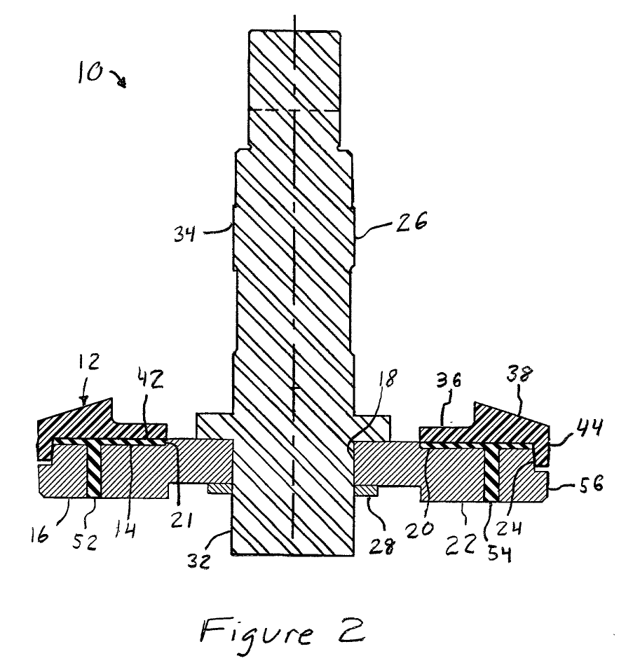

FIG. 1 shows a partially exploded isometric view of a first embodiment, and FIG. 2 shows a detailed cross sectional view of a second embodiment. Composite gear assembly 10 includes a face 12, dampening layer 14, and a backing 16.

Backing 16 is preferably a plate having a central opening 18 to facilitate a press-fit assembly with shaft 26. Backing 16 includes a face surface 20, a back surface 22, and an edge surface 24. Exemplary materials for backing 16 include, but are not limited to, metals, high-strength carbon compounds, ceramics, or other materials having high structural integrity. In one embodiment, backing 16 is a powdered metal hub formed of granular ferrous material disposed in a mold, pressed, and sintered. Of course, it is contemplated that backing 16 may be formed by any means, including but not limited to machining steel.

Dampening layer 14 may be an elastomeric material provided with adhesive properties. Alternatively, dampening layer 14 may be an elastomeric material bonded to neighboring parts by a separate layer of adhesive (not shown). Layer 14 is generally defined by face surface 20 and a step portion 21 of backing 16, and a bottom surface 42 and inside diameter of a step portion 44 of face 12.

Where the adhesive properties of the material for dampening layer 14 are sufficient, face surface 20 may be smooth. To complement the adhesion, torque carrying capability, or limit relative angular displacement between face 12 and backing 16, provided by dampening layer 14, molded features such as posts extending from bottom surface 42 of face 12 into slightly larger holes in backing 16 can be added. Alternatively, either or both face surface 20 and bottom surface 42 may be provided with one or more mechanical features (not shown) such as knurls, ridges, or other patterns formed thereon. As yet another alternative, mechanical features alone may provide the adhesion between face surface 20 and face 12, wherein dampening layer 14 is provided for noise and/or stress dampening.

In one embodiment, an output shaft 26 having a stop ring 28 is generally press fitted through opening 18 of backing 16. Stop ring 28 defines the location of backing 16 upon shaft 26. Shaft 26 generally includes precision ground diameters 32, 34 which serve as datum features for accurate positioning during processing, and as bearing journals in the final assembly.

Face 12 is an injection molded, polymeric component. Face 12 is formed to have a top surface 36 comprising a plurality of generally upstanding gear teeth 38 and a bottom surface 42 that facially opposes face surface 20 of backing 16. Furthermore, face 12 includes step portion 44 that extends past the outer circumference of face surface 20 and contacts edge surface 24. Exemplary materials for face 12 include, but are not limited to, nylon or nylon based polymeric compounds, or such other polymeric materials exhibiting high-strength and ease of moldability.

Gear teeth 38 typically mesh with other gears, including worm gears or pinions, for example, within an electric power steering system. Gear teeth 38 may be arranged to form gear configurations including, but not limited to, various bevel gear configurations, such as spiral and hypoid gears, etc. such as those sold under the trademark SPIROID or HELICON from Illinois Tool Works, Inc of Glenview, Ill.

Dampening layer 14 is provided between face 12 and backing 16 to provide noise and vibrational dampening. Additionally, dampening layer 14 may also completely or partially adhere gear face 12 and backing 16. Dampening layer 14 is typically an elastomer that is injected between face 12 and backing 16, described further herein, and may include a bonding agent to completely or partially adhere face 12 and backing 16. The elastomeric material for dampening layer 14 may comprise styrene ethylbutylene styrene (SEBS) block copolymer compounds. A SEBS compound marketed under the trade name TEKBOND by Teknor Apex Company of Pawtucket, R.I. has been found particularly useful as an elastomer having adhesive properties.

One or more sets of openings 52, 54 are provided within backing plate 16. Opening 52 is provided to inject the elastomer, as described further herein. Opening 54 may be provided to verify the quantity of material injected through openings 52 to form dampening layer 14.

Backing 16 can be provided with a lip 56 extending from edge surface 24 adjacent to back surface 22. Lip 56 interfaces with step portion 44 to determine the maximum distance from the back that dampening layer 14 may be axially compressed by face 12. It is, of course, contemplated that where over-compression of dampening layer 14 is of minimal effect or inconsequential, lip 56 may be eliminated.

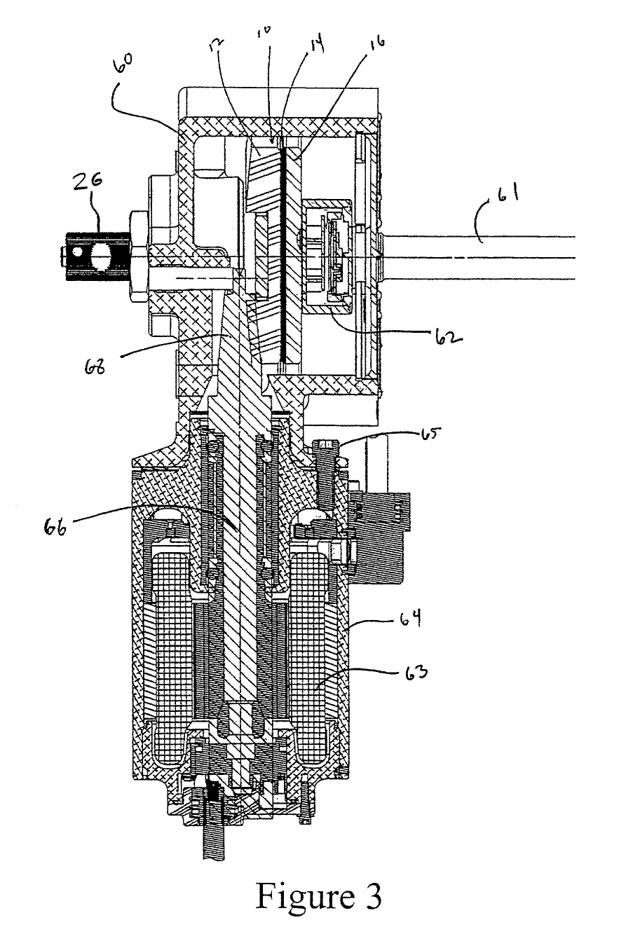

Referring now to FIG. 3, gear assembly 10 is depicted as a component of an EPS system within a gear housing 60. The input shaft 61 of the system is connected to a steering column (not shown). A torque sensor 62, internal to the gear housing 60 senses driver input torque. An electronic control module (not shown) interprets the input torque and other vehicle inputs, such as vehicle speed, and provides a signal to an electric motor 63. Electric motor 63 is within a motor housing 64 that attaches to gear housing 60 via one or more bolts 65. As motor 63 is energized, motor shaft 66 having pinion 68 at the end thereof rotates. The rotation of pinion 68 meshes face 12 of gear assembly 10, which in turn rotates shaft 26 extending from gear housing 60. Shaft 26 is the output shaft of the EPS system, generally connected to an intermediate shaft or rack and pinion gear box (not shown).

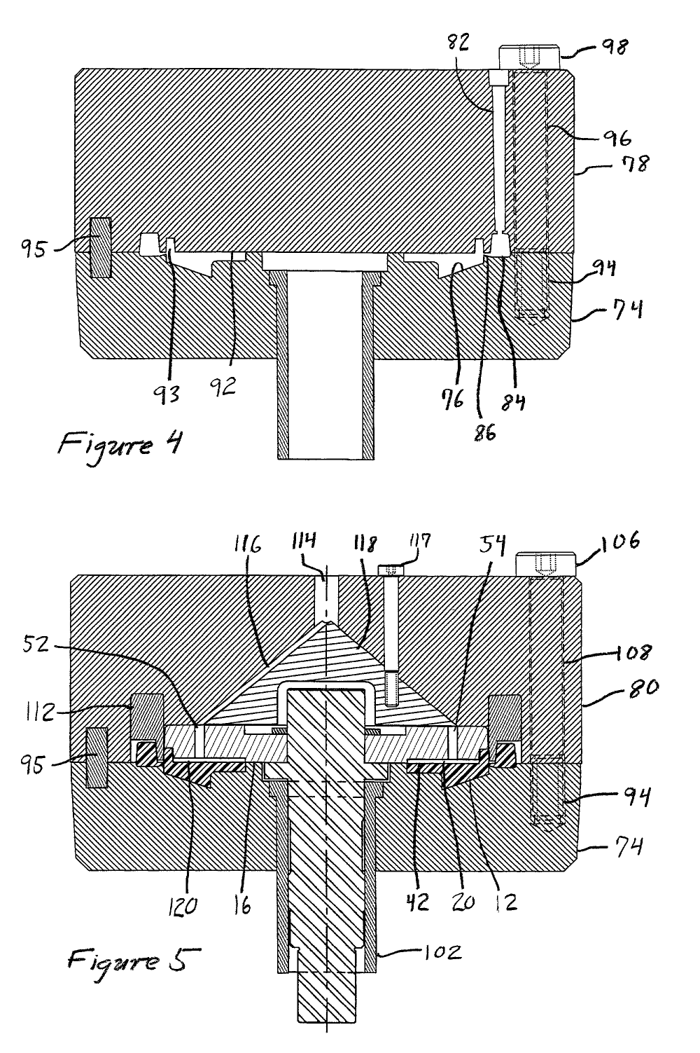

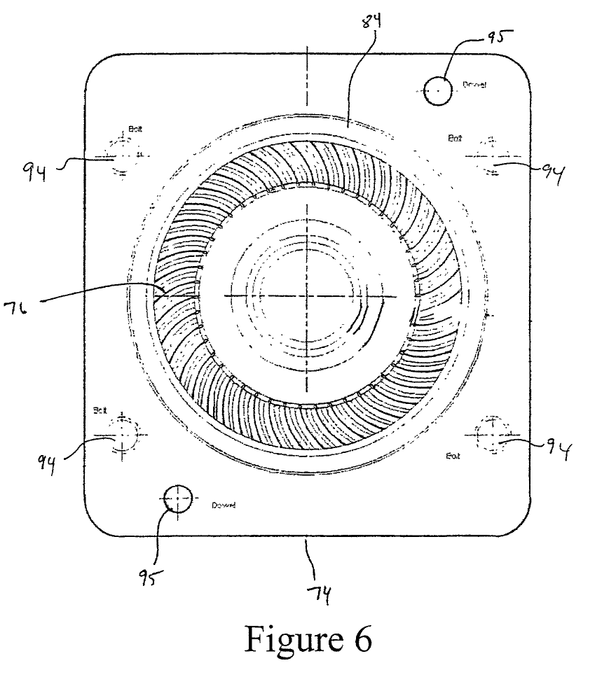

Referring now to FIGS. 4 and 6 the first step to fabricate gear assembly 10 as schematically depicted. A mold cavity insert 74 is provided having a cutaway portion 76 complementary to the shape of top surface 36 having gear teeth 38 of face 12 (FIG. 2). Bottom surface 42 of face 12 is formed by flat portion 92 of first changeable mold 78. Step portion 44 of face 12 is formed by a complementary cutaway groove 93 in first changeable mold 78.

Mold cavity insert 74 is part of a dual material injection molding system. In a first stage injection molding process, mold cavity insert 74, or the “B” mold half, mates with a changeable first changeable mold 78, or the first “A” mold, to form face 12. Molten polymeric material, for example, a nylon or nylon based compound, is injected through the first changeable mold 78 by one or more gate drops 82. Gate drops 82 have a tapered cross-section for removal of remaining material after hardening. The material is forced through gate drops 82 into an outer diameter runner 84 arranged concentrically around outer diameter of cutaway portion 76. The material flows from outer diameter runner 84 into cutaway portion 76 and cutaway groove 93 via a diaphragm gate 86.

Mold cavity insert 74 includes a plurality of threaded holes 94 (one of which is depicted in FIG. 4) that is complementary to a plurality of openings 96 in first changeable mold 78 for passage of bolts 98 therethrough, generally to secure mold cavity insert 74 to first changeable mold 78 under high-pressure conditions that exist during injection molding. It is, of course, contemplated that other securement means, including but not limited to clamps and automatic machine systems, may be provided in addition to or in lieu of bolts 98.

Furthermore, one or more dowels and/or guide pins 95 may optionally be included that interface mold cavity insert 74 and first changeable mold 78 to maintain positional control of the mold parts.

The material forming face 12 remains within mold cavity insert 74 until it has solidified sufficiently. The “A” mold, or first changeable mold 78, is then removed.

Referring now to FIGS. 2 and 5, shaft 26 having stop ring 28 is press fitted through opening 18 of backing 16 (generally in a previous operation) and the assembly including backing 16 and shaft 26 is inserted within mold cavity insert 74. This insertion may be accomplished manually or automatically. The shaft 26 is aligned within a bushing 102 disposed within a cavity 104 centrally located within mold cavity insert 74. Bushing 102 is dimensioned complementary to the shaft diameters 32, 34.

Referring to FIG. 5, in a second stage injection molding process, mold cavity insert 74 having face 12 therein mates with a second changeable mold “A”, or a second changeable mold 80. It is contemplated that the transition from first changeable mold 78 (FIG. 4) to second changeable mold 80 can be by various means, including, but not limited to, by rotation, shuttling, or other displacement means.

Second changeable mold 80 is positioned over mold cavity insert 74. The molds are held together by a bolt 106 disposed through an opening 108 in second changeable mold 80 and opening 94 in mold cavity insert 74. It is, of course, contemplated that other securement means, including but not limited to clamps or automatic machine systems, may be provided in addition to or in lieu of bolt 106. By securing backing 16 to mold cavity insert 74, such systems may obviate any need for second changeable mold 80, allowing the dampening layer to be directed directly through backing 16. One or more dowels and/or guide pins 95 may optionally be included that interface mold cavity inserts 74 and 80 to maintain positional control of the mold parts.

Additionally, second changeable mold 80 includes a ring support 112. Ring support 112 holds face 12 and backing 16 at outer diameter portion 44 and edge surface 24 (FIG. 2).

Molten elastomeric material (e.g., SEBS) is injected through a sprue 114 upon second changeable mold 80. The molten elastomeric material traverses down one or more runners 116 arranged on a runner block 118. Runner block 118 is removably fastened to second changeable mold 80 by screws 117 (only one shown). Runners 116 are arranged to direct the molten elastomeric material into openings 52 within backing 16. The material is injected until a space 120 between face surface 20 of backing 16 and bottom surface 42 of face 12 is filled with elastomeric material, thereby forming dampening layer 14 shown in FIG. 2.

Opening 54 may be employed to monitor the filling of space 120. This monitoring may be accomplished by visual inspection. Alternatively, cavity pressure of the elastomeric material forming dampening layer 14 may be monitored with transducers at opening 54 as an automatic, in process, quality check.

In one embodiment, three openings 52 and three opening 54 are provided. Accordingly, three runners 116 are arranged on runner block 118.

After dampening layer 14 has cooled for a sufficient period of time, second changeable mold 80 is decoupled from mold cavity insert 74. The resultant gear assembly 10 is then removed from mold cavity insert 74. By virtue of the dampening properties imparted by dampening layer 14, noise, shock, and vibration within a device such as an electronic power steering system is minimized.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. A gear assembly comprising:
a gear face having at least one gear tooth;
a backing for supporting said gear face; and
an dampening layer disposed between said gear face and said backing.

2. The gear assembly of claim 1 wherein said dampening layer is injection molded between said gear face and said backing.

3. The gear assembly of claim 2 wherein said backing comprises a first opening, and wherein said dampening layer is injected molded through said first opening.

4. The gear assembly of claim 3 wherein said backing comprises a second opening effective for visual inspection of said dampening layer while said dampening layer is being injected molded through said first opening.

5. The gear assembly of claim 4 further comprising cavity transducers to monitor said dampening layer while said dampening layer is being injected molded through said first opening.

6. The gear assembly of claim 1 wherein said gear face is formed of a polymeric material.

7. The gear assembly as in claim 6, wherein said polymeric material is nylon.

8. The gear assembly as in claim 1, wherein said dampening layer is an elastomeric material.

9. The gear assembly as in claim 8, wherein the elastomeric material is styrene ethylbutylene styrene block copolymer compounds.

10. The gear assembly as in claim 1, wherein said dampening layer partially adheres to said gear face and to said backing.

11. A method of producing a dampened assembly comprising:
injecting a moldable material through a first changeable mold into a mold cavity insert to form a first component of said dampened assembly;
decoupling said first changeable mold from said mold cavity insert;
inserting a second component of said dampened assembly upon said mold cavity insert;
injecting an elastomeric material between said first component and said second component.

12. The method of claim 11 wherein said injecting an elastomeric material includes injecting said elastomeric material through a second changeable mold insert.

13. The method of claim 11 wherein said first component comprises a gear face and said second component comprises a metal backing.

14. The method of claim 11 wherein said first component comprises a polymer.

15. The method of claim 14 wherein said first component comprises nylon.

16. The method of claim 11 wherein said elastomeric material forms an adhesive bond to said first component and said second component.

17. The method of claim 11 wherein said elastomeric material comprises styrene ethylbutylene styrene block copolymer compounds.
